(19) United States
(12) Patent Application Publication
(10) Pub. No.: US 2026/0262101 A1
(43) Pub. Date: Sep. 3, 2026

(54) FURTHER ENHANCEMENTS TO RA REPORT

(71) Applicant: QUALCOMM Incorporated, San Diego, CA (US)

(72) Inventors: Shankar KRISHNAN, Poway, CA (US); Rajeev KUMAR, San Diego, CA (US); Ruiming ZHENG, Beijing (CN)

(21) Appl. No.: 19/492,104

(22) PCT Filed: Sep. 8, 2023
(86) PCT No.: PCT/CN2023/117656

§ 371 Date: Dec. 10, 2025

(51) Int. Cl. H04W 74/0833; H04B 7/06; H04B 17/318

(52) U.S. Cl. CPC H04W 74/0833; H04B 7/06952; H04B 17/328

(57) ABSTRACT

A method for wireless communication at a user equipment (UE) and related apparatus are provided. In the method, the UE initiates a random-access channel (RACH) procedure with a network entity; and generate, upon a successful completion of the RACH procedure, a report. The report includes one or more of: an indicator indicating whether a message 1-repetition (MSG1-repetition) feature was utilized for the RACH procedure, a first RACH purpose indicating the RACH procedure is triggered for a link recovery procedure, or a second RACH purpose indicating the RACH procedure is initiated for mobile terminated-small data transfer (MT-SDT). The UE further transmits the report to the network entity.

### TECHNICAL FIELD

The present disclosure relates generally to communication systems, and more particularly, to the enhancements to the random access (RA) report in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to initiate a random-access channel (RACH) procedure with a network entity; and generate, upon a successful completion of the RACH procedure, a report. The report may include one or more of: an indicator indicating whether a message 1-repetition (MSG1-repetition) feature was utilized for the RACH procedure, a first RACH purpose indicating the RACH procedure is triggered for a link recovery procedure, or a second RACH purpose indicating the RACH procedure is initiated for mobile terminated-small data transfer (MT-SDT). The at least one processor, individually or in any combination, may be further configured to transmit the report to the network entity.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to initiate a RACH procedure with a UE; and receive, from the UE upon a successful completion of the RACH procedure, a report. The report may include one or more of: an indicator indicating whether the MSG1-repetition feature was utilized for the RACH procedure, a first RACH purpose indicating the RACH procedure is triggered for a link recovery procedure, or a second RACH purpose indicating the RACH procedure is initiated for MT-SDT.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example cell switch via lower-layer triggered mobility (LTM).

FIG. 5 is a diagram illustrating an example of early timing advance (TA) acquisition during LTM.

FIG. 6 is a call flow diagram illustrating a method of wireless communication in accordance with various aspects of the present disclosure.

FIG. 7 is a flowchart illustrating methods of wireless communication at a UE in accordance with various aspects of the present disclosure.

FIG. 8 is a flowchart illustrating methods of wireless communication at a UE in accordance with various aspects of the present disclosure.

FIG. 9 is a flowchart illustrating methods of wireless communication at a network entity in accordance with various aspects of the present disclosure.

FIG. 10 is a flowchart illustrating methods of wireless communication at a network entity in accordance with various aspects of the present disclosure.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

A user equipment (UE) may perform a random-access channel (RACH) procedure with a network (e.g., a gNB) to initiate the communication with the network. The information related to the RACH procedure, such as the outcome (e.g., failure or success) of the RACH procedure, may be communicated between the UE and the network via a RACH report (or random access (RA) report). To improve the efficiency of wireless communication, it is desirable to reduce the access delays due to failed RACH attempts, allocate appropriate RACH resources to minimize RACH collisions (e.g., a scenario where multiple devices send requests over the RACH at the same time), and facilitate the detection of physical random access channel (PRACH) configuration conflicts (e.g., the mismatch among multiple PRACH configuration settings). Example aspects presented herein aim to optimize RACH procedures and the subsequent reporting through a number of enhancements. Among these are methods to indicate the use of features such as Message 1 (MSG1) repetition in the RA report, methods for RA report enhancements for lower-layer triggered mobility (LTM) and mobile terminated-single data transfer (MT-SDT).

Various aspects relate generally to wireless communication. Some aspects more specifically relate to the enhancements to the RA report in wireless communication. In some examples, a UE initiates a RACH procedure with a network entity, and generate a report upon a successful completion of the RACH procedure. The report may include one or more of an indicator that indicates whether the MSG1 repetition feature was utilized for the RACH procedure, a first RACH purpose indicating the RACH procedure is triggered for a link recovery procedure, or a second RACH purpose indicating the RACH procedure is initiated for MT-SDT. The UE further transmits the report to the network entity.

Particular aspects of the subject matter described in this disclosure can be implemented to realize one or more of the following potential advantages. In some examples, by enabling the recording and transmission of more detailed RA reports, including information related to the MSG1 repetition, LTM, or MT-SDT, the described methods may be used to minimize access delays due to failed RACH attempts and optimize the allocation of resources, thereby improving the efficiency of wireless communication. In some examples, by allowing the UE to indicate to the network whether the MSG1 repetition feature was used for a RACH procedure, the described techniques enable the network to adjust and optimize its operations according to the conditions of the RACH procedure. In some examples, by enabling a new RACH purpose to indicate the association of the RACH procedure with LTM or MT-SDT procedures, the described techniques increase the effectiveness and efficiency of the RACH procedure in these circumstances.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

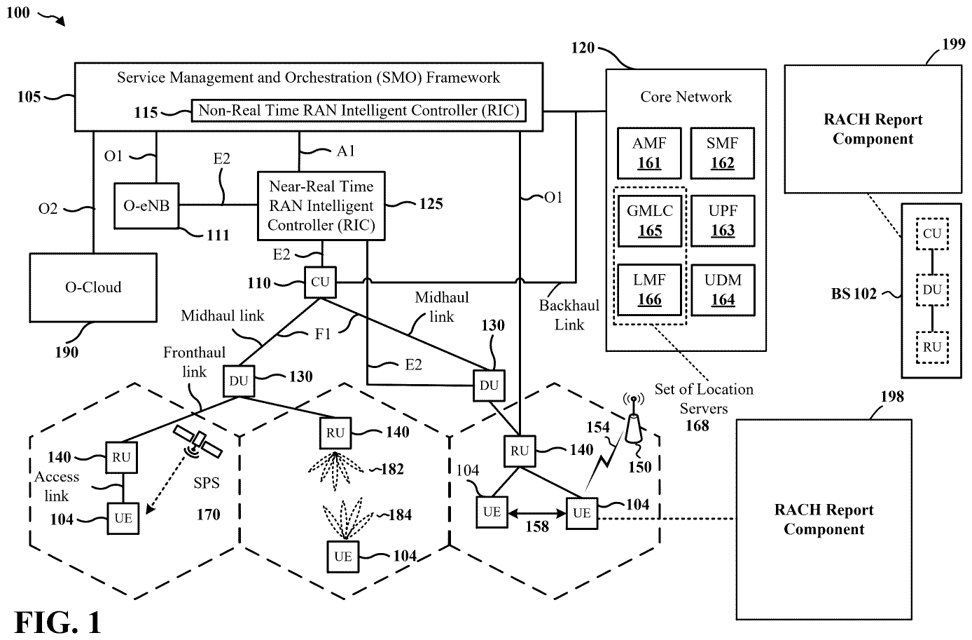

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHZ-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a RACH report component 198. The RACH report component 198 may be configured to initiate a RACH procedure with a network entity, and generate a report upon a successful completion of the RACH procedure. The report may include one or more of: an indicator indicating whether the MSG1-repetition feature was utilized for the RACH procedure, a first RACH purpose indicating the RACH procedure is triggered for a link recovery procedure, or a second RACH purpose indicating the RACH procedure is initiated for MT-SDT. The RACH report component 198 may be further configured to transmit the report to the network entity. In certain aspects, the base station 102 may include a RACH report component 199. The RACH report component 199 may be configured to initiate a RACH procedure with a UE; and receive, from the UE upon a successful completion of the RACH procedure, a report, wherein the report includes one or more of: an indicator indicating whether the MSG1-repetition feature was utilized for the RACH procedure, a first RACH purpose indicating the RACH procedure is triggered for a link recovery procedure, or a second RACH purpose indicating the RACH procedure is initiated for MT-SDT. Although the following description may be focused on 5G NR, the concepts described herein may be applicable to other similar areas, such as LTE, LTE-A, CDMA, GSM, and other wireless technologies.

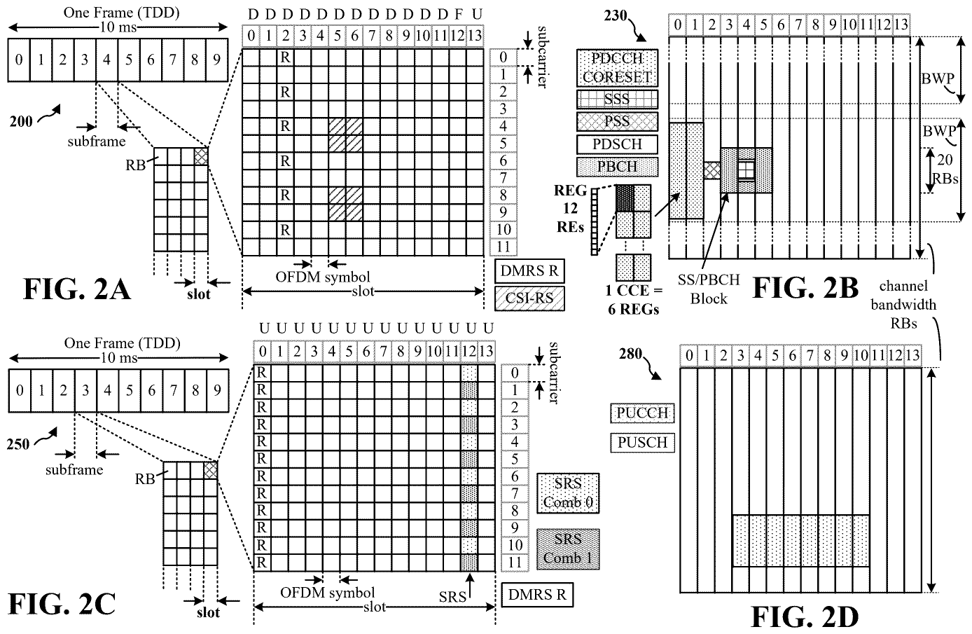

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

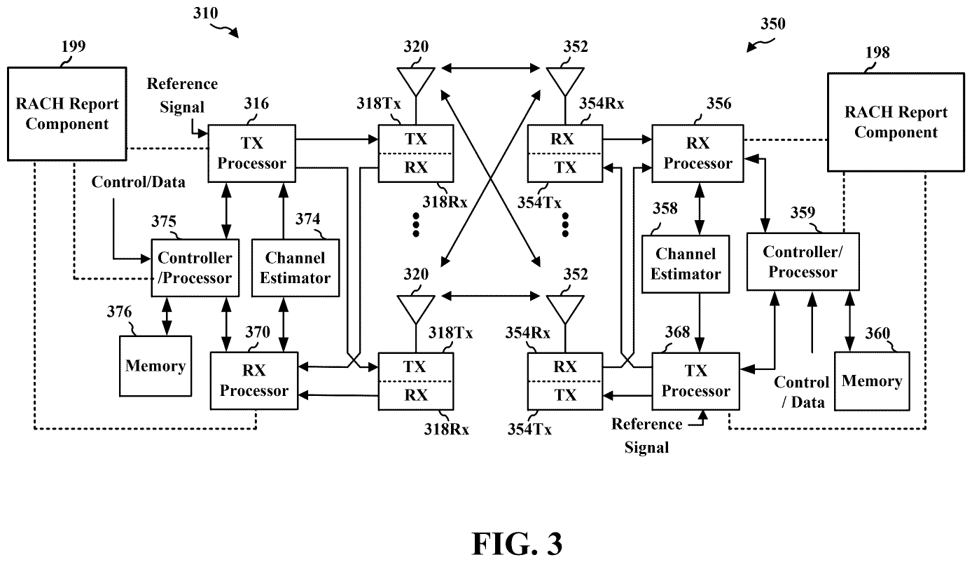

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality. The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the RACH report component 198 of FIG. 1.

At least one of the TX processor 316, the RX processor 370, and the controller/processor 375 may be configured to perform aspects in connection with the RACH report component 199 of FIG. 1.

Example aspects presented herein provide extensions to the RA report framework to cover newly introduced use cases, including coverage enhancements, LTM, and MT-SDT.

A RACH procedure may be performed to initiate or reestablish communication between the UE and the network (e.g., during handover or data transmission). During a RACH procedure, the UE sends an initial message, which may be referred to as Message 1 or MSG1, to the network. The MSG1 may contain a “preamble” that informs the network of the UE's intent to connect. To increase the likelihood of the network successfully receiving and recognizing the preamble, the UE may transmit the MSG1 multiple times, a process called MSG1 repetition. The MSG1 repetition is beneficial in poor radio conditions, in which the MSG1 may be lost during the transmission, or to mitigate possible collisions, which may occur when multiple UEs send preambles simultaneously.

In the RACH procedure, a report (e.g., a random access report, RACH report, or RA report) may be generated to record detailed information related to the RACH procedure. For example, after successfully completing the RACH procedure, the UE may record an entry in the RA report. Up to, for example, eight entries may be recorded in the RA report. Example aspects presented herein aim to optimize RACH procedures and the subsequent reporting through several enhancements to the RA report, including the enhancements related to MSG1 repetition for coverage enhancement and the enhancements for LTM and MT-SDT.

In some aspects, a UE may indicate to the network (e.g., a base station) whether the “MSG1-Repetition” feature was utilized during a RACH procedure. This could be achieved by, for example, including “MSG1-Repetitions” as the feature combination used within the parameter RA-InformationCommon. This parameter may be included in various reports, including an RA report, radio link failure (RLF) report, charging enablement function (CEF) report, successful handover report (SHR), subscriber profile repository (SPR), and SCGFailureInformation.

In some aspects, a UE may include the MSG1 repetition number used during each RA procedure in the parameter RA-InformationCommon. For example, the MSG1 repetition number may be 2, 4, or 8.

In some aspects, multiple reference signal received power (RSRP) thresholds may be configured for different repetition numbers. For example, for the Msg1 repetition, multiple synchronization signal block-reference signal received power (SSB-RSRP) thresholds may be configured, and each SSB-RSRP threshold may be associated with a specific Msg1 repetition number. If a UE's RSRP on the downlink pathloss reference is lower than a given threshold, then the corresponding Msg1 repetition number and the RA resources may be applied for the current random-access procedure.

In some aspects, when a UE indicates that the quality of the DL beam (e.g., the SSB) exceeds a certain threshold defined as, for example, “rsrp-ThresholdSSB” in the RA report, then the UE may also indicate which SSB-RSRP threshold of the multiple SSB-RSRP thresholds the quality of the DL beam is above.

In a RACH procedure, various fallback cases may be used. The fallback strategy allows a device to transition to an alternative, more suitable communication technology if the current technology is not available or encounters issues, ensuring communication reliability. For example, the fallback cases may include the fallback from a RACH procedure that does not involve any MSG1 repetition to a RACH procedure with MSG1 repetition, the fallback from the MSG1 repetition with a lower repetition number to a higher repetition number, the fallback from 2-step RACH procedure to 4-step RACH procedure with MSG1 repetition, or the fallback from contention-free random access (CFRA), where the transmission resources are preconfigured to the UE, eliminating potential contentions or collisions with other UEs, to contention-based random access (CBRA) with MSG1 repetition, where there is a chance for multiple UEs to select the same transmission resources, leading to potential “contention” or collision.

In some aspects, a UE may use a 1-bit flag to indicate, for example, a fallback from the MSG1 repetition of a lower number to the MSG1 repetition of a higher number. In some aspects, the UE may further mention the number of MSG1 repetitions before the fallback and the number of MSG1 repetitions after the fallback.

In wireless communication, cell switch can be triggered by layer 1 (L1) or layer 2 (L2) command, a process known as lower-layer triggered mobility (LTM), or layer 1 (L1)/layer 2 (L2) triggered mobility. For example, a medium access control (MAC)-control element (MAC-CE) may be used to trigger the mobility and carry LTM-related information for the cell switch. Both RACH-based (including CFRA and CBRA) and RACH-less procedures may be used for LTM switching. For example, if the UE does not acquire timing advance (TA) during the cell switch, a RACH-less approach may be utilized. On the other hand, RACH resources for CFRA in cell switching may be provided in the RRC configuration. LTM cell switch may be supervised by a timer, and the UE's arrival in the target cell may be indicated.

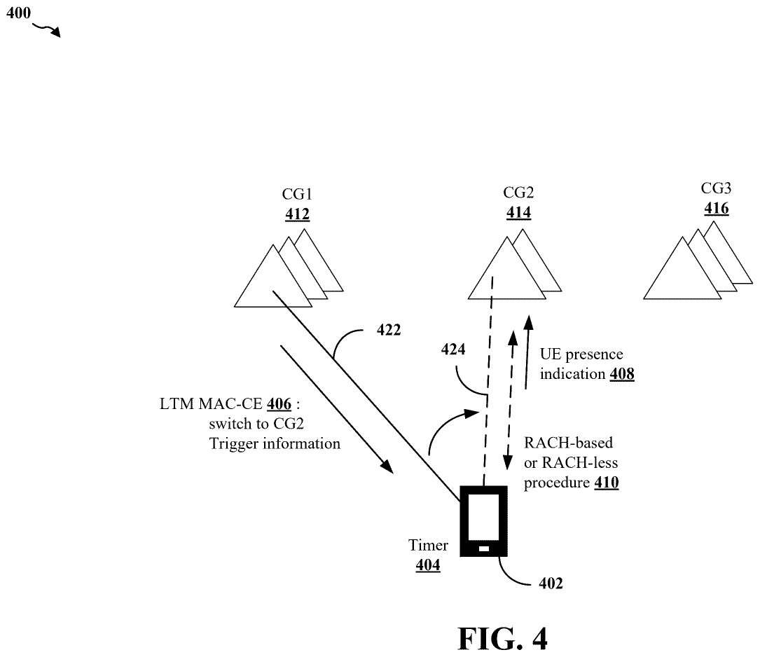

FIG. 4 is a diagram 400 illustrating an example cell switch via LTM. In FIG. 4, the UE 402 was initially connected (at 422) with cell group 1 (CG1) 412. Through LTM, and the UE 402 may switch the cell to connect (via 424) with cell group 2 (CG2) 414. During the LTM, CG1 412 may send a MAC-CE 406 to the UE 402. The MAC-CE 406 may include, for example, an indication to switch to CG2 414 and LTM-related information for the cell switch. A RACH-based or RACH-less procedure 410 may be performed for the LTM switch. The LTM cell switch may be supervised by a timer 404, and the UE 402 may indicate its arrival to the target cell (CG2 414) via, for example, the UE presence indication 408. FIG. 4 also shows a cell group 3 (CG3) 416.

In some aspects, if a RACH procedure is performed during the LTM (e.g., when the TA is not synchronized between CG1 412 and CG2 414), the RA report may include a new RACH purpose (e.g., a second RACH purpose) to indicate that the RACH procedure was triggered for link recovery (e.g., to synchronize TA during LTM). Alternatively, an existing RACH purpose, such as ulUnSynchronized, may be reused in the RA report to indicate that the RACH procedure was triggered for link recovery (e.g., to synchronize TA during LTM).

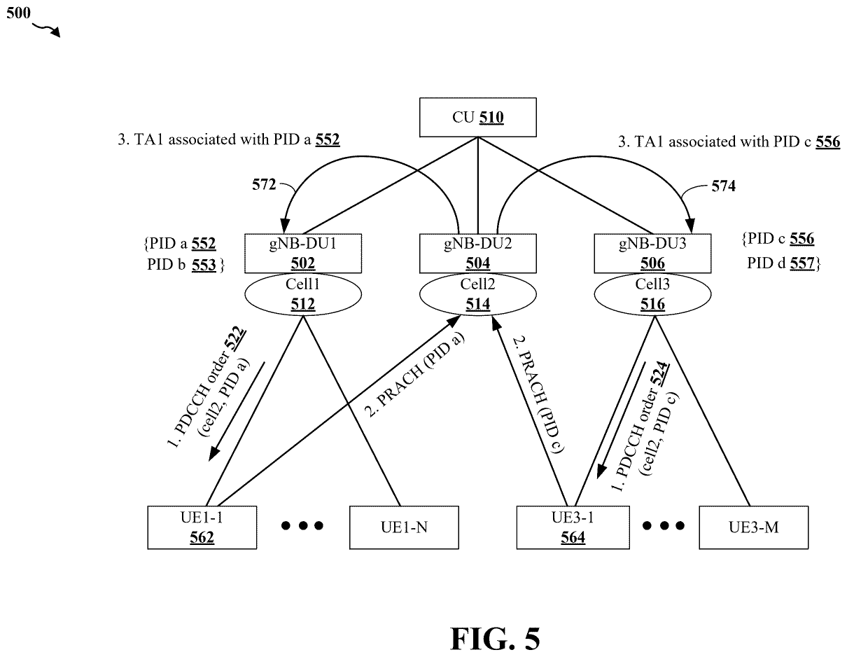

In some aspects, the RA report may be optimized for early TA acquisition during LTM. “Early TA acquisition” refers to the process of obtaining the TA earlier in the communication setup process. In some examples, multiple UEs may share the CFRA resource for early TA acquisition. FIG. 5 is a diagram 500 illustrating an example of early TA acquisition during LTM. In FIG. 5, each DU (e.g., gNB-DU1 502, gNB-DU2 504, or gNB-DU3 506) or each cell (e.g., cell1 512, cell2 514, or cell3 516) may be associated with a pool of preambles. For example, cell1 512 may be associated with the pool of preambles that includes preamble ID (PID) a 552 and PID b 553, cell2 516 may be associated with the pool of preambles that includes PID c 556 and PID d 557. When cell1 512 sends to a UE (e.g., UE1-1 562) a PDCCH order 522 to perform a RACH procedure with cell2 514 using preamble PID a 552, the UE (e.g., UE1-1 562) may send the preamble PID a 552 to cell2 514 via a physical random access channel (PRACH) procedure, for example. Similarly, when cell3 516 sends to a UE (e.g., UE3-1 564) a PDCCH order 524 to perform a RACH procedure with cell2 514 using preamble PID c 556, the UE (e.g., UE3-1 564) may send the preamble PID c 556 to cell2 514 via a physical random access channel (PRACH) procedure, for example.

In some aspects, to optimize the pool of CFRA resources allocated to each candidate DU for early TA acquisition, a network entity (e.g., a DU) may collect RACH statistics, such as the number of successful and failed RACH attempts associated with each preamble. This data then may be shared with other network entities (e.g., other DUs through the CU 510). For example, in FIG. 5, cell2 514 may collect the RACH statistics, such as the number of RACH successes or failures with preamble PID a 552, and the number of RACH successes or failures with preamble PID c 556. Cell2 514 may share the RACH statistics with other cells, such as cell1 502 (via 572) or cell3 516 (via 574). Based on the RACH statistic, a cell may adjust the pool of preamble associated with it. For example, if cell2 514 collects the RACH statistics indicating that preamble PID a 552 has a large number of RACH failures and shares the RACH statistics with cell1 512, cell1 512 may adjust its pool of preamble based on the RACH statistics (e.g., remove preamble PID a 552 from the pool due to the large number of RACH failures).

In some aspects, the RA report enhancement may be made for the MT-SDT. The enhancements may optimize the RACH resources used during the MT-SDT and improve the MT-SDT procedure itself. During MT-SDT, the UE may use random access-small data transfer (RA-SDT) resources if there is available UL data and mobile-originated small data transfer (MO-SDT) is configured. However, if a MO-SDT is not configured, or if UL smaller data transfer (SDT) data is not available at the UE, or even in situations where the UE has UL data but still uses non-SDT RA, the UE may use non-SDT RA resources.

In some aspects, several new RACH purposes may be defined in the RA Report. For example, one such purpose may be “RACH for MT-SDT,” which would be used when a new RACH is initiated for the MT-SDT. Another RACH purpose may be related to the scenario where the time gap between the next configured grant (CG) and the SDT occasion is too far (e.g., the time gap between initiation of the SDT procedure and the next CG-SDT occasion is larger than the parameter cg-SDT-MaxDurationToNext-CG-Occasion). Alternatively, if the RACH purpose is set as “RACH for MT-SDT,” the UE may indicate whether the time gap between the initiation of the SDT procedure and the next CG-SDT occasion is larger than a threshold (e.g., the parameter cg-SDT-MaxDurationToNext-CG-Occasion).

In some aspects, the UE may further indicate in the RA Report or other self-organizing network (SON) reports, such as the charging enablement function (CEF) report, the UL SDT data volume prior to the initiation of a RACH-based MT-SDT, or alternatively, an indication of the availability of UL SDT data. Additionally, the UE may further indicate in the RA report or other SON reports, such as the CEF report, the RSRP value prior to the initiation of the MT-SDT procedure.

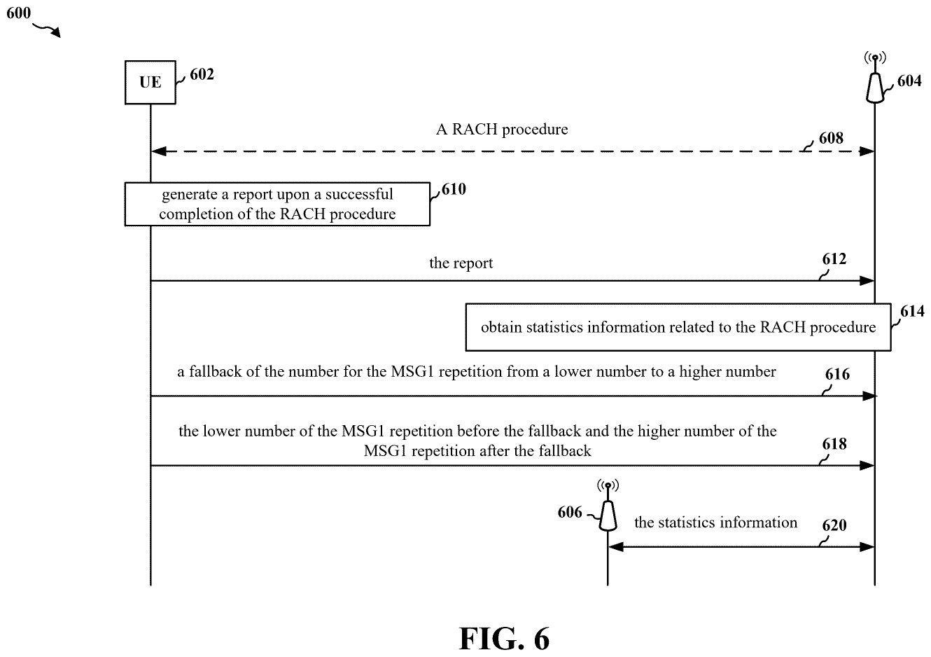

FIG. 6 is a call flow diagram 600 illustrating a method of wireless communication in accordance with various aspects of this present disclosure. Various aspects are described in connection with a UE 602 and a base station 604. The aspects may be performed by the UE 602 or the base station 604 in aggregation and/or by one or more components of a base station 604 (e.g., such as a CU 110, a DU 130, and/or an RU 140).

As shown in FIG. 6, at 608, a UE 602 may initiate a RACH procedure with a base station 604.

At 610, upon a successful completion of the RACH procedure, the UE 602 may generate a report. The report may include one or more of an indicator indicating whether the MSG1-repetition feature was utilized for the RACH procedure, a first RACH purpose indicating the RACH procedure is triggered for a link recovery procedure (a procedure to restore communication when a link between two entities, such as between a base station and a UE, experiences degradation or failure), or a second RACH purpose indicating the RACH procedure is initiated for MT-SDT.

At 612, the UE 602 may transmit the report to the base station 604. For example, referring to FIG. 5, the UE (e.g., UE1-1 562 and UE3-1 564) may transmit the report to the base station (e.g., cell 2 514).

At 614, the base station 604 may obtain statistics information related to the RACH procedure based on the report. The statistics information related to the RACH procedure may include, for example, the number of RACH successes/failures per preamble used. For example, referring to FIG. 5, the base station (cell2 514) may obtain statistics information related to the RACH procedure based on the report. The statistics information related to the RACH procedure may include, for example, the number of RACH successes/failures per preamble used (e.g., the number of RACH successes/failures for each of preamble PID a 552 and preamble PID c 556).

At 616, the UE 602 may indicate, to the base station 604 via a one-bit flag, that there is a fallback of the number of the MSG1 repetition from a lower number to a higher number.

At 618, the UE 602 may indicate, to the base station 604, the number of MSG1 repetition before the fallback and the number of the MSG1 repetition after the fallback.

At 620, the base station 604 may exchange the statistics information related to the RACH procedures (e.g., the number of RACH successes/failures) with a second base station 606. In some examples, the base station 604 may transmit the statics information it collected to the second base station 606. In some examples, the base station 604 may receive the statistics information collected by the second base station 606 from the second base station 606. For example, referring to FIG. 5, the base station (e.g., cell2 514) may exchange the statistics information related to the RACH procedures (e.g., the number of RACH successes/failures for preamble PID a 552 and preamble PID c 556) with a second base station (e.g., cell1 512 or cell3 516).

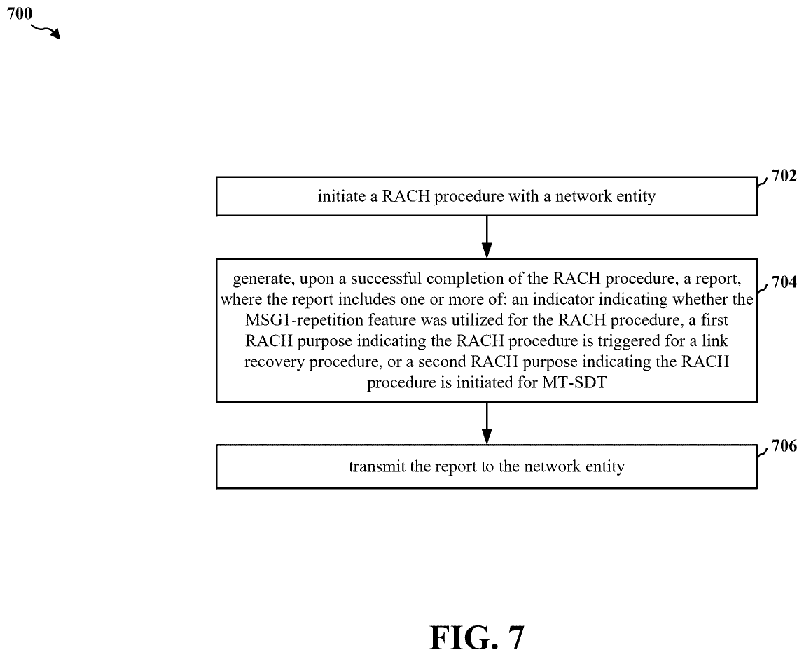

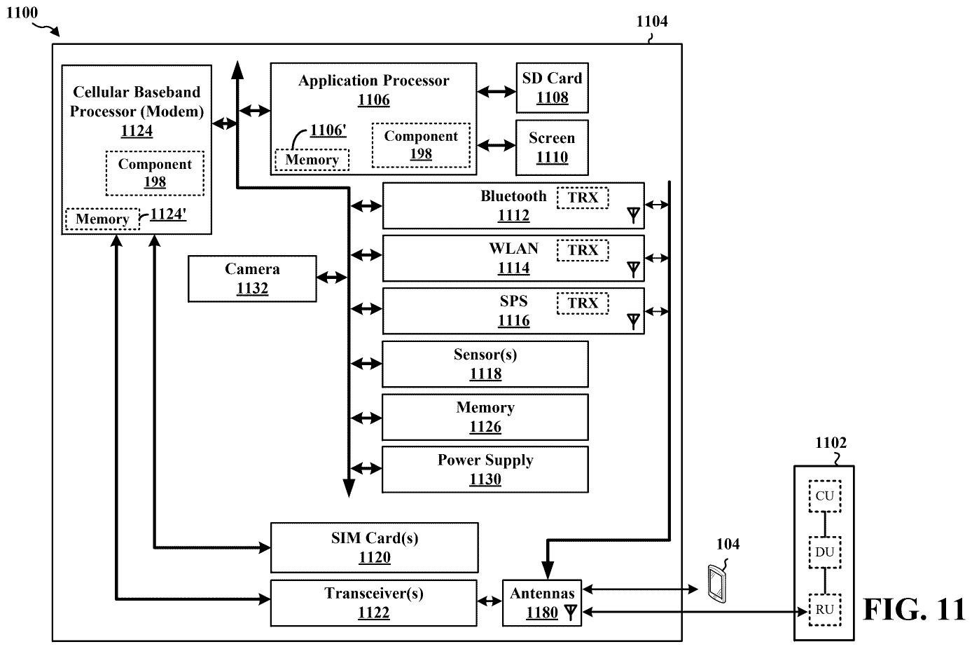

FIG. 7 is a flowchart 700 illustrating methods of wireless communication at a UE in accordance with various aspects of the present disclosure. The method may be performed by a UE. The UE may be the UE 104, 350, 402, 562, 564, 602, or the apparatus 1104 in the hardware implementation of FIG. 11. The methods enable the recording and transmission of more detailed RA reports, including information related to the MSG1 repetition, LTM, or MT-SDT. The methods aid in minimizing access delays due to failed RACH attempts and optimize the allocation of resources, thereby improving the efficiency of wireless communication.

As shown in FIG. 7, at 702, the UE may initiate a RACH procedure with a network entity. The network entity may be a base station, or a component of a base station, in the access network of FIG. 1 or a core network component (e.g., base station 102, 310, 604; cells 512, 514, 516; or the network entity 1102 in the hardware implementation of FIG. 11). FIGS. 4, 5, and 6 illustrate various aspects of the steps in connection with flowchart 700. For example, referring to FIG. 6, the UE 602 may initiate, at 608, a RACH procedure with a network entity (base station 604). In some examples, 702 may be performed by the RACH report component 198.

At 704, the UE may generate, upon a successful completion of the RACH procedure, a report. The report may include one or more of: an indicator indicating whether the MSG1-repetition feature was utilized for the RACH procedure, a first RACH purpose indicating the RACH procedure is triggered for a link recovery procedure, or a second RACH purpose indicating the RACH procedure is initiated for MT-SDT. For example, referring to FIG. 6, the UE 602 may generate, at 610 upon a successful completion of the RACH procedure, a report. The report may include one or more of: an indicator indicating whether the MSG1-repetition feature was utilized for the RACH procedure, a first RACH purpose indicating the RACH procedure is triggered for a link recovery procedure, or a second RACH purpose indicating the RACH procedure is initiated for MT-SDT. In some examples, 704 may be performed by the RACH report component 198.

At 706, the UE may transmit the report to the network entity. For example, referring to FIG. 6, the UE 602 may transmit, at 612, the report to the network entity (base station 604). Referring to FIG. 5, the UE (e.g., UE1-1 562 and UE3-1 564) may transmit the report to the base station (e.g., cell 2 514). In some examples, 706 may be performed by the RACH report component 198.

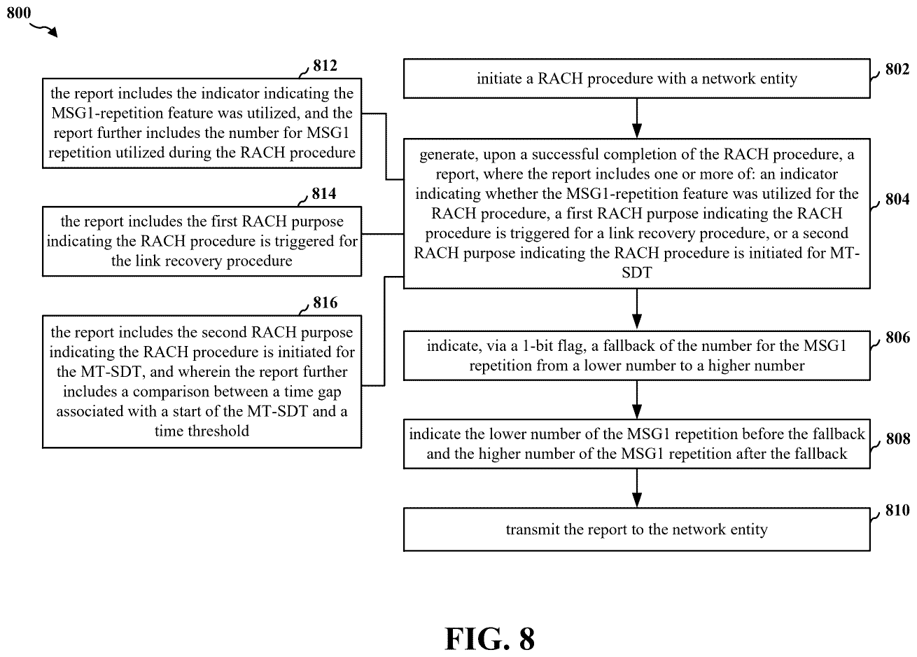

FIG. 8 is a flowchart 800 illustrating methods of wireless communication at a UE in accordance with various aspects of the present disclosure. The method may be performed by a UE. The UE may be the UE 104, 350, 402, 562, 564, 602, or the apparatus 1104 in the hardware implementation of FIG. 11. The methods enable the recording and transmission of more detailed RA reports, including information related to the MSG1 repetition, LTM, or MT-SDT. The methods aid in minimizing access delays due to failed RACH attempts and optimize the allocation of resources, thereby improving the efficiency of wireless communication.

As shown in FIG. 8, at 802, the UE may initiate a RACH procedure with a network entity. The network entity may be a base station, or a component of a base station, in the access network of FIG. 1 or a core network component (e.g., base station 102, 310, 604; cells 512, 514, 516; or the network entity 1102 in the hardware implementation of FIG. 11). FIGS. 4, 5, and 6 illustrate various aspects of the steps in connection with flowchart 800. For example, referring to FIG. 6, the UE 602 may initiate, at 608, a RACH procedure with a network entity (base station 604). In some examples, 802 may be performed by the RACH report component 198.

At 804, the UE may generate, upon a successful completion of the RACH procedure, a report. The report may include one or more of: an indicator indicating whether the MSG1-repetition feature was utilized for the RACH procedure, a first RACH purpose indicating the RACH procedure is triggered for a link recovery procedure, or a second RACH purpose indicating the RACH procedure is initiated for MT-SDT. For example, referring to FIG. 6, the UE 602 may generate, at 610 upon a successful completion of the RACH procedure, a report. The report may include one or more of: an indicator indicating whether the MSG1-repetition feature was utilized for the RACH procedure, a first RACH purpose indicating the RACH procedure is triggered for a link recovery procedure, or a second RACH purpose indicating the RACH procedure is initiated for MT-SDT. In some examples, 804 may be performed by the RACH report component 198.

At 810, the UE may transmit the report to the network entity. For example, referring to FIG. 6, the UE 602 may transmit, at 612, the report to the network entity (base station 604). Referring to FIG. 5, the UE (e.g., UE1-1 562 and UE3-1 564) may transmit the report to the base station (e.g., cell 2 514). In some examples, 810 may be performed by the RACH report component 198.

In some aspects, the report may be a RACH report. For example, referring to FIG. 6, the report (at 612) may be a RACH report. In some examples, the report (at 612) may be other types of report, such as a CEF report.

In some aspects, at 812, the report may include the indicator that indicates the MSG1-repetition feature was utilized, and the report may further include the number for MSG1 repetition utilized during the RACH procedure. For example, referring to FIG. 6, the report (at 612) may include the indicator that indicates the MSG1-repetition feature was utilized, and the report (at 612) may further include the number for MSG1 repetition utilized during the RACH procedure.

In some aspects, the report may further include a threshold indicator that indicates one quality threshold among multiple quality thresholds with which a DL beam quality is measured, and the multiple quality thresholds may be respectively associated with different numbers of the MSG1 repetition. For example, referring to FIG. 6, the report (at 612) may further include a threshold indicator that indicates one quality threshold among multiple quality thresholds with which a DL beam quality is measured, and the multiple quality thresholds may be respectively associated with different numbers of the MSG1 repetition.

In some aspects, the multiple quality thresholds may be multiple SSB-RSRP thresholds. For example, referring to FIG. 6, the multiple quality thresholds for the report (at 612) may be multiple SSB-RSRP thresholds.

In some aspects, at 806, the UE may indicate, via a 1-bit flag, a fallback of the number for the MSG1 repetition from a lower number to a higher number. For example, referring to FIG. 6, the UE 602 may indicate, at 616, via a 1-bit flag, a fallback of the number for the MSG1 repetition from a lower number to a higher number. In some examples, 806 may be performed by the RACH report component 198.

In some aspects, at 808, the UE may indicate the lower number of the MSG1 repetition before the fallback and the higher number of the MSG1 repetition after the fallback. For example, referring to FIG. 6, the UE 602 may indicate, at 618, the lower number of the MSG1 repetition before the fallback and the higher number of the MSG1 repetition after the fallback. In some examples, 808 may be performed by the RACH report component 198.

In some aspects, at 814, the report may include the first RACH purpose that indicates the RACH procedure is triggered for the link recovery procedure. For example, referring to FIG. 6, the report (at 612) may include the first RACH purpose that indicates the RACH procedure is triggered for the link recovery procedure. Referring to 4, the report (the UE 402 sends to CG2 414) may include the first RACH purpose that indicates the RACH procedure is triggered for the link recovery procedure.

In some aspects, the link recovery procedure may include the synchronization of a timing advance during LTM. For example, referring to FIG. 6, the link recovery procedure (for which the RACH procedure 608 was triggered) may include the synchronization of a timing advance during LTM.

In some aspects, at 816, the report may include the second RACH purpose that indicates the RACH procedure is initiated for the MT-SDT, and the report may further include the comparison between a time gap associated with the start of the MT-SDT and a time threshold. For example, referring to FIG. 6, the report (at 612) may include the second RACH purpose that indicates the RACH procedure is initiated for the MT-SDT, and the report (at 612) may further include the comparison between a time gap associated with the start of the MT-SDT and a time threshold.

In some aspects, the time gap may be the time interval between the start of the MT-SDT and the next CG-SDT occasion, and the time threshold may be the maximum duration allowed between the start of SDT and the next CG-SDT occasion. For example, referring to FIG. 6, the report (at 612) may indicate whether the time interval between the start of the MT-SDT and the next CG-SDT occasion is larger than the time threshold, which may be the maximum duration allowed between the start of SDT and the next CG-SDT occasion. For example, the time threshold may be represented by the parameter cg-SDT-MaxDurationToNext-CG-Occasion.

In some aspects, the report may further include an uplink data volume prior to the initiation of the RACH procedure, or a data indicator that indicates the availability of uplink SDT data. For example, referring to FIG. 6, the report (at 612) may further include an uplink data volume prior to the initiation of the RACH procedure (at 608), or a data indicator that indicates the availability of uplink SDT data.

In some aspects, the report may further include the RSRP prior to the initiation of the RACH procedure. For example, referring to FIG. 6, the report (at 612) may further include the RSRP prior to the initiation of the RACH procedure (at 608).

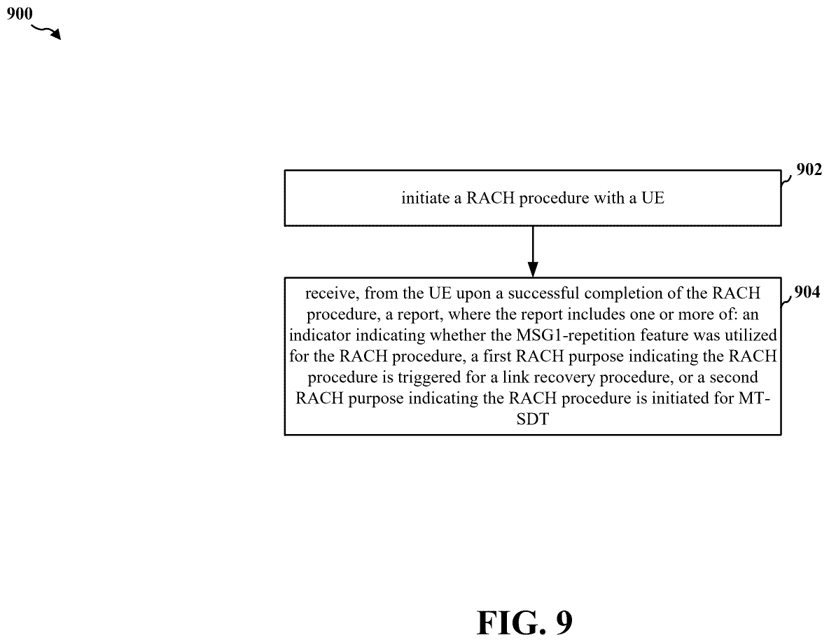

FIG. 9 is a flowchart 900 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 604; cells 512, 514, 516; or the network entity 1102 in the hardware implementation of FIG. 11). The methods enable the recording and transmission of more detailed RA reports, including information related to the MSG1 repetition, LTM, or MT-SDT. The methods aid in minimizing access delays due to failed RACH attempts and optimize the allocation of resources, thereby improving the efficiency of wireless communication.

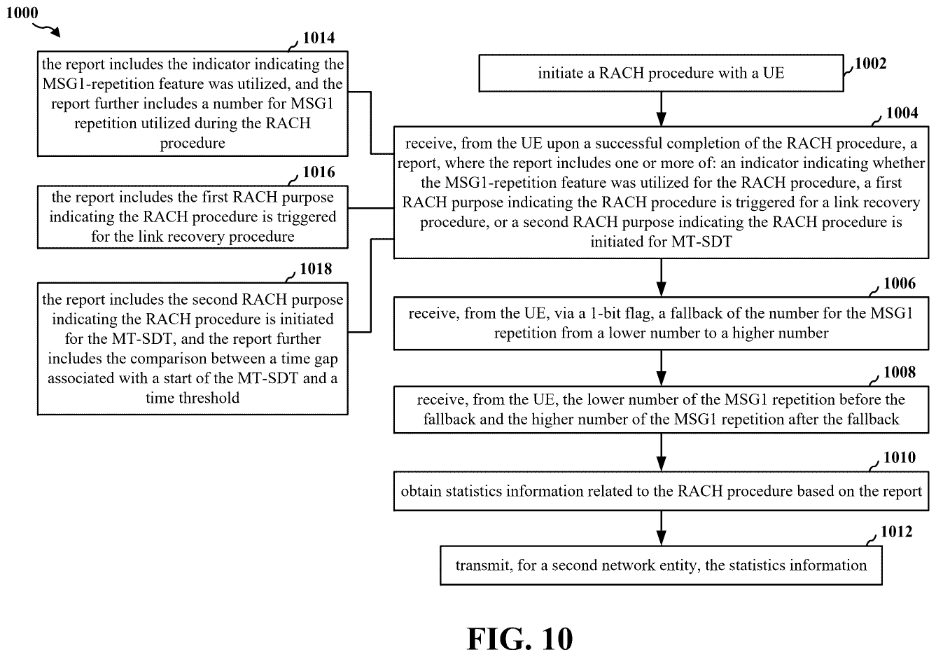

As shown in FIG. 9, at 902, the network entity may initiate a RACH procedure with a UE. The UE may be the UE 104, 350, 402, 562, 564, 602, or the apparatus 1104 in the hardware implementation of FIG. 11. FIGS. 4, 5, and 6 illustrate various aspects of the steps in connection with flowchart 900. For example, referring to FIG. 6, the network entity (base station 604) may, at 608, initiate a RACH procedure with a UE 602. In some examples, 902 may be performed by the RACH report component 199. At 904, the network entity may receive, from the UE upon a successful completion of the RACH procedure, a report. The report includes one or more of: an indicator indicating whether the MSG1-repetition feature was utilized for the RACH procedure, a first RACH purpose indicating the RACH procedure is triggered for a link recovery procedure, or a second RACH purpose indicating the RACH procedure is initiated for MT-SDT. For example, referring to FIG. 6, the network entity (base station 604) may receive, at 612 from the UE 602 upon a successful completion of the RACH procedure, a report. The report includes one or more of: an indicator indicating whether the MSG1-repetition feature was utilized for the RACH procedure, a first RACH purpose indicating the RACH procedure is triggered for a link recovery procedure, or a second RACH purpose indicating the RACH procedure is initiated for MT-SDT. In some aspects, 904 may be performed the RACH report component 199. FIG. 10 is a flowchart 1000 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 604; cells 512, 514, 516; or the network entity 1102 in the hardware implementation of FIG. 11). The methods enable the recording and transmission of more detailed RA reports, including information related to the MSG1 repetition, LTM, or MT-SDT. The methods aid in minimizing access delays due to failed RACH attempts and optimize the allocation of resources, thereby improving the efficiency of wireless communication.

As shown in FIG. 10, at 1002, the network entity may initiate a RACH procedure with a UE. The UE may be the UE 104, 350, 402, 562, 564, 602, or the apparatus 1104 in the hardware implementation of FIG. 11. FIGS. 4, 5, and 6 illustrate various aspects of the steps in connection with flowchart 1000. For example, referring to FIG. 6, the network entity (base station 604) may, at 608, initiate a RACH procedure with a UE 602. In some examples, 1002 may be performed by the RACH report component 199.

At 1004, the network entity may receive, from the UE upon a successful completion of the RACH procedure, a report. The report includes one or more of: an indicator indicating whether the MSG1-repetition feature was utilized for the RACH procedure, a first RACH purpose indicating the RACH procedure is triggered for a link recovery procedure, or a second RACH purpose indicating the RACH procedure is initiated for MT-SDT. For example, referring to FIG. 6, the network entity (base station 604) may receive, at 612 from the UE 602 upon a successful completion of the RACH procedure, a report. The report includes one or more of: an indicator indicating whether the MSG1-repetition feature was utilized for the RACH procedure, a first RACH purpose indicating the RACH procedure is triggered for a link recovery procedure, or a second RACH purpose indicating the RACH procedure is initiated for MT-SDT. In some aspects, 1004 may be performed the RACH report component 199. In some aspects, the report may be a RACH report. For example, referring to FIG. 6, the report (at 612) may be a RACH report. In some examples, the report (at 612) may be other types of report, such as a CEF report.

In some aspects, at 1014, the report may include the indicator indicating the MSG1-repetition feature was utilized, and the report may further include a number for MSG1 repetition utilized during the RACH procedure. For example, referring to FIG. 6, the report (at 612) may include the indicator that indicates the MSG1-repetition feature was utilized, and the report (at 612) may further include the number for MSG1 repetition utilized during the RACH procedure.

In some aspects, the report may further include a threshold indicator that indicates one quality threshold among multiple quality thresholds with which a DL beam quality is measured, and the multiple quality thresholds may be respectively associated with different numbers of the MSG1 repetition. For example, referring to FIG. 6, the report (at 612) may further include a threshold indicator that indicates one quality threshold among multiple quality thresholds with which a DL beam quality is measured, and the multiple quality thresholds may be respectively associated with different numbers of the MSG1 repetition.

In some aspects, the multiple quality thresholds may be multiple SSB-RSRP thresholds. For example, referring to FIG. 6, the multiple quality thresholds for the report (at 612) may be multiple SSB-RSRP thresholds.

In some aspects, at 1006, the network entity may receive, from the UE, via a 1-bit flag, a fallback of the number for the MSG1 repetition from a lower number to a higher number. For example, referring to FIG. 6, the network entity (base station 604) may receive, at 616 from the UE 602, via a 1-bit flag, a fallback of the number for the MSG1 repetition from a lower number to a higher number. In some aspects, 1006 may be performed the RACH report component 199.

In some aspects, at 1008, the network entity may receive, from the UE, the lower number of the MSG1 repetition before the fallback and the higher number of the MSG1 repetition after the fallback. For example, referring to FIG. 6, the network entity (base station 604) may receive, at 618 from the UE 602, the lower number of the MSG1 repetition before the fallback and the higher number of the MSG1 repetition after the fallback. In some aspects, 1008 may be performed the RACH report component 199.

In some aspects, at 1016, the report may include the first RACH purpose that indicates the RACH procedure is triggered for the link recovery procedure. For example, referring to FIG. 6, the report (at 612) may include the first RACH purpose that indicates the RACH procedure is triggered for the link recovery procedure. Referring to 4, the report (the UE 402 sends to CG2 414) may include the first RACH purpose that indicates the RACH procedure is triggered for the link recovery procedure.

In some aspects, the link recovery procedure may include the synchronization of a timing advance during LTM. For example, referring to FIG. 6, the link recovery procedure (for which the RACH procedure 608 was triggered) may include the synchronization of a timing advance during LTM.

In some aspects, the network entity may be a first network entity, and the first network entity may, at 1010, obtain statistics information related to the RACH procedure based on the report, and at 1012, transmit, for a second network entity, the statistics information. For example, referring to FIG. 6, the first network entity (base station 604) may, at 614, obtain statistics information related to the RACH procedure based on the report (at 612), and at 620, transmit, for a second network entity (second base station 606), the statistics information. Referring to FIG. 5, the first network entity (e.g., cell2 514) may obtain statistics information related to the RACH procedure (e.g., the number of RACH successes/failures for preamble PID a 552 or preamble PID c 556), and transmit, for a second network entity (e.g., cell1 512 or cell3 516), the statistics information. In some aspects, 1010 and 1012 may be performed the RACH report component 199.

In some aspects, the statistics information may include one or more: the number of successfully completed RACH procedures per preamble used on the UE, or the number of failed RACH procedures per preamble used on the UE. For example, referring to FIG. 5, the statistics information may include the number of successfully completed RACH procedures per preamble (e.g., the number of successfully completed RACH procedures for preamble PID a 552 or PID c 556) used on the UE, or the number of failed RACH procedures per preamble (e.g., the number of failed RACH procedures for preamble PID a 552 or PID c 556) used on the UE.

In some aspects, at 1018, the report may include the second RACH purpose indicating the RACH procedure is initiated for the MT-SDT, and the report may further include the comparison between a time gap associated with the start of the MT-SDT and a time threshold. For example, referring to FIG. 6, the report (at 612) may include the second RACH purpose that indicates the RACH procedure is initiated for the MT-SDT, and the report (at 612) may further include the comparison between a time gap associated with the start of the MT-SDT and a time threshold.

In some aspects, the time gap may be the time interval between the start of the MT-SDT and the next CG-SDT occasion, and the time threshold may be the maximum duration allowed between the start of SDT and the next CG-SDT occasion. For example, referring to FIG. 6, the report (at 612) may indicate whether the time interval between the start of the MT-SDT and the next CG-SDT occasion is larger than the time threshold, which may be the maximum duration allowed between the start of SDT and the next CG-SDT occasion. For example, the time threshold may be represented by the parameter cg-SDT-MaxDurationToNext-CG-Occasion.

In some aspects, the report may further include an uplink data volume prior to the initiation of the RACH procedure, or a data indicator that indicates the availability of uplink SDT data. For example, referring to FIG. 6, the report (at 612) may further include an uplink data volume prior to the initiation of the RACH procedure (at 608), or a data indicator that indicates the availability of uplink SDT data.

In some aspects, the report may further include the RSRP prior to the initiation of the RACH procedure. For example, referring to FIG. 6, the report (at 612) may further include the RSRP prior to the initiation of the RACH procedure (at 608).

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The cellular baseband processor(s) 1124 and the application processor(s) 1106 are configured to perform the various functions described supra based at least in part of the information stored in the memory. That is, the cellular baseband processor(s) 1124 and the application processor(s) 1106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the component 198 may be configured to initiate a RACH procedure with a network entity; and generate, upon a successful completion of the RACH procedure, a report. The report may include one or more of: an indicator indicating whether the MSG1-repetition feature was utilized for the RACH procedure, a first RACH purpose indicating the RACH procedure is triggered for a link recovery procedure, or a second RACH purpose indicating the RACH procedure is initiated for mobile terminated-small data transfer (MT-SDT). The component 198 may be further configured to transmit the report to the network entity. The component 198 may be further configured to perform any of the aspects described in connection with the flowcharts in FIG. 7 and FIG. 8, and/or performed by the UE 602 in FIG. 6. The component 198 may be within the cellular baseband processor(s) 1124, the application processor(s) 1106, or both the cellular baseband processor(s) 1124 and the application processor(s) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, includes means for initiating a RACH procedure with a network entity, and means for generating, upon a successful completion of the RACH procedure, a report The report may include one or more of: an indicator indicating whether the MSG1-repetition feature was utilized for the RACH procedure, a first RACH purpose indicating the RACH procedure is triggered for a link recovery procedure, or a second RACH purpose indicating the RACH procedure is initiated for MT-SDT. The apparatus 1104, and in particular the cellular baseband processor(s) 1124 and/or the application processor(s) 1106, may further include means for transmitting the report to the network entity. The apparatus 1104 may further include means for performing any of the aspects described in connection with the flowcharts in FIG. 7 and FIG. 8, and/or aspects performed by the UE 602 in FIG. 6. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

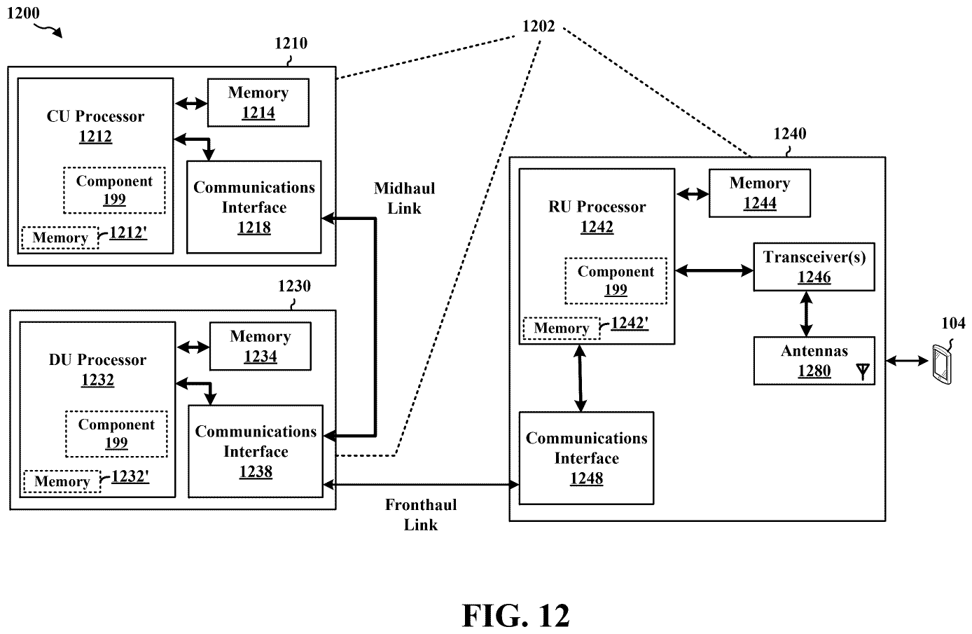

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to initiate a RACH procedure with a UE; and receive, from the UE upon a successful completion of the RACH procedure, a report. The report may include one or more of: an indicator indicating whether the MSG1-repetition feature was utilized for the RACH procedure, a first RACH purpose indicating the RACH procedure is triggered for a link recovery procedure, or a second RACH purpose indicating the RACH procedure is initiated for MT-SDT. The component 199 may be further configured to perform any of the aspects described in connection with the flowcharts in FIG. 9 and FIG. 10, and/or performed by the base station 604 in FIG. 6. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 includes means for initiating a RACH procedure with a UE, and means for receiving, from the UE upon a successful completion of the RACH procedure, a report. The report may include one or more of: an indicator indicating whether the MSG1-repetition feature was utilized for the RACH procedure, a first RACH purpose indicating the RACH procedure is triggered for a link recovery procedure, or a second RACH purpose indicating the RACH procedure is initiated for MT-SDT. The network entity 1202 may further include means for performing any of the aspects described in connection with the flowcharts in FIG. 9 and FIG. 10, and/or aspects performed by the base station 604 in FIG. 6.

The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include initiating a RACH procedure with a network entity; and generating, upon a successful completion of the RACH procedure, a report. The report may include one or more of: an indicator indicating whether the MSG1-repetition feature was utilized for the RACH procedure, a first RACH purpose indicating the RACH procedure is triggered for a link recovery procedure, or a second RACH purpose indicating the RACH procedure is initiated for MT-SDT. The method may further include transmitting the report to the network entity. The methods enable the recording and transmission of more detailed RA reports, including information related to the MSG1 repetition, LTM, or MT-SDT. The methods aid in minimizing access delays due to failed RACH attempts and optimize the allocation of resources, thereby improving the efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method may include initiating a random-access channel (RACH) procedure with a network entity; generating, upon a successful completion of the RACH procedure, a report, wherein the report includes one or more of: an indicator indicating whether a message 1-repetition (MSG1-repetition) feature was utilized for the RACH procedure, a first RACH purpose indicating the RACH procedure is triggered for a link recovery procedure, or a second RACH purpose indicating the RACH procedure is initiated for mobile terminated-small data transfer (MT-SDT); and transmit the report to the network entity.

Aspect 2 is the method of aspect 1, wherein the report may be a RACH report.

Aspect 3 is the method of any of aspects 1 to 2, wherein the report may include the indicator indicating the MSG1-repetition feature was utilized, and wherein the report may further include a number for MSG1 repetition utilized during the RACH procedure.

Aspect 4 is the method of aspect 3, wherein the report may further include a threshold indicator that indicates one quality threshold among multiple quality thresholds with which a downlink (DL) beam quality is measured, and wherein the multiple quality thresholds may be respectively associated with different numbers of the MSG1 repetition.

Aspect 5 is the method of aspect 4, wherein the multiple quality thresholds may be multiple synchronization signal block-reference signal received power (SSB-RSRP) thresholds.

Aspect 6 is the method of any of aspects 3 to 5, where the method may further include indicating, via a 1-bit flag, a fallback of the number for the MSG1 repetition from a lower number to a higher number.

Aspect 7 is the method of aspect 6, where the method may further include indicating the lower number of the MSG1 repetition before the fallback and the higher number of the MSG1 repetition after the fallback.

Aspect 8 is the method of any of aspects 1 to 2, wherein the report may include the first RACH purpose indicating the RACH procedure is triggered for the link recovery procedure.

Aspect 9 is the method of aspect 8, wherein the link recovery procedure may include the synchronization of a timing advance during lower-layer-triggered mobility (LTM).

Aspect 10 is the method of any of aspects 1 to 2, wherein the report may include the second RACH purpose indicating the RACH procedure is initiated for the MT-SDT, and wherein the report may further include a comparison between a time gap associated with the start of the MT-SDT and a time threshold.

Aspect 11 is the method of aspect 10, wherein the time gap may be a time interval between the start of the MT-SDT and a next configured grant (CG)-SDT occasion, and wherein the time threshold may be the maximum duration allowed between the start of SDT and the next CG-SDT occasion.

Aspect 12 is the method of aspect 10, wherein the report may further include an uplink data volume prior to the initiation of the RACH procedure, or a data indicator indicating an availability of uplink SDT data.

Aspect 13 is the method of aspect 10, wherein the report may further include a reference signal received power (RSRP) prior to the initiation of the RACH procedure.

Aspect 14 is an apparatus for wireless communication at a UE, comprising: at least one memory; and at least one processor coupled to the at least one memory and, based at least in part on information stored in the at least one memory, the at least one processor, individually or in any combination, is configured to perform the method of any of aspects 1-13.

Aspect 15 is the apparatus for wireless communication at a UE, comprising means for performing each step in the method of any of aspects 1-13.

Aspect 16 is an apparatus of any of aspects 14-15, further comprising a transceiver configured to receive or to transmit in association with the method of any of aspects 1-13.

Aspect 17 is a computer-readable medium (e.g., a non-transitory computer-readable medium) storing computer executable code at a UE, the code when executed by at least one processor causes the at least one processor to, individually or in any combination, perform the method of any of aspects 1-13.

Aspect 18 is a method of wireless communication at a network entity. The method may include initiating a random-access channel (RACH) procedure with a user equipment (UE); and receiving, from the UE upon a successful completion of the RACH procedure, a report, wherein the report may include one or more of: an indicator indicating whether a message 1-repetition (MSG1-repetition) feature was utilized for the RACH procedure, a first RACH purpose indicating the RACH procedure is triggered for a link recovery procedure, or a second RACH purpose indicating the RACH procedure is initiated for mobile terminated-small data transfer (MT-SDT).

Aspect 19 is the method of aspect 18, wherein the report may be a RACH report.

Aspect 20 is the method of any of aspects 18 to 19, wherein the report may include the indicator indicating the MSG1-repetition feature was utilized, and wherein the report may further include a number for MSG1 repetition utilized during the RACH procedure.

Aspect 21 is the method of aspect 20, wherein the report may further include a threshold indicator indicating one quality threshold among multiple quality thresholds with which a downlink (DL) beam quality is measured, and wherein the multiple quality thresholds may be respectively associated with different numbers of the MSG1 repetition.

Aspect 22 is the method of aspect 21, wherein the multiple quality thresholds may be multiple synchronization signal block-reference signal received power (SSB-RSRP) thresholds.

Aspect 23 is the method of any of aspects 18 to 22, where the method may further include receiving, from the UE, via a 1-bit flag, a fallback of the number for the MSG1 repetition from a lower number to a higher number.

Aspect 24 is the method of aspect 23, where the method may further include receiving, from the UE, the lower number of the MSG1 repetition before the fallback and the higher number of the MSG1 repetition after the fallback.

Aspect 25 is the method of any of aspects 18 to 19, wherein the report may include the first RACH purpose indicating the RACH procedure is triggered for the link recovery procedure.

Aspect 26 is the method of aspect 25, wherein the link recovery procedure may include the synchronization of a timing advance during lower-layer-triggered mobility (LTM).

Aspect 27 is the method of any of aspects 18 to 19, wherein the network entity may be a first network entity, and wherein the method may further include obtaining statistics information related to the RACH procedure based on the report; and transmitting, for a second network entity, the statistics information.

Aspect 28 is the method of aspect 27, wherein the statistics information may include one or more: the number of successfully completed RACH procedures per preamble used on the UE, or the number of failed RACH procedures per preamble used on the UE.

Aspect 29 is the method of any of aspects 18 to 19, wherein the report may include the second RACH purpose indicating the RACH procedure is initiated for the MT-SDT, and wherein the report may further include the comparison between a time gap associated with the start of the MT-SDT and a time threshold.

Aspect 30 is the method of aspect 29, wherein the time gap may be the time interval between the start of the MT-SDT and a next configured grant (CG)-SDT occasion, and wherein the time threshold may be the maximum duration allowed between the start of SDT and the next CG-SDT occasion.

Aspect 31 is the method of aspect 29, wherein the report may further include an uplink data volume prior to the initiation of the RACH procedure, or a data indicator indicating an availability of uplink SDT data.

Aspect 32 is the method of aspect 29, wherein the report may further include a reference signal received power (RSRP) prior to the initiation of the RACH procedure.

Aspect 33 is an apparatus for wireless communication at a network entity, comprising: at least one memory; and at least one processor coupled to the at least one memory and, based at least in part on information stored in the at least one memory, the at least one processor, individually or in any combination, is configured to perform the method of any of aspects 18-32.

Aspect 34 is the apparatus for wireless communication at a network entity, comprising means for performing each step in the method of any of aspects 18-32.

Aspect 35 is an apparatus of any of aspects 33-34, further comprising a transceiver configured to receive or to transmit in association with the method of any of aspects 18-32.

Aspect 36 is a computer-readable medium (e.g., a non-transitory computer-readable medium) storing computer executable code at a network entity, the code when executed by at least one processor causes the at least one processor to, individually or in any combination, perform the method of any of aspects 18-32.

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
initiate a random-access channel (RACH) procedure with a network entity;
generate, upon a successful completion of the RACH procedure, a report, wherein the report includes one or more of:
an indicator indicating whether a message 1-repetition (MSG1-repetition) feature was utilized for the RACH procedure,
a first RACH purpose indicating the RACH procedure is triggered for a link recovery procedure, or
a second RACH purpose indicating the RACH procedure is initiated for mobile terminated-small data transfer (MT-SDT); and
transmit the report to the network entity.

2. The apparatus of claim 1, further comprising a transceiver coupled to the at least one processor, wherein, to transmit the report, the at least one processor, individually or in any combination, is configured to transmit the report via the transceiver, and wherein the report is a RACH report.

3. The apparatus of claim 1, wherein the report includes the indicator indicating the MSG1-repetition feature was utilized, and wherein the report further includes a number for MSG1 repetition utilized during the RACH procedure.

4. The apparatus of claim 3, wherein the report further includes a threshold indicator that indicates one quality threshold among multiple quality thresholds with which a downlink (DL) beam quality is measured, and wherein the multiple quality thresholds are respectively associated with different numbers of the MSG1 repetition.

5. The apparatus of claim 4, wherein the multiple quality thresholds are multiple synchronization signal block-reference signal received power (SSB-RSRP) thresholds.

6. The apparatus of claim 3, wherein the at least one processor, individually or in any combination, is further configured to:
indicate, via a 1-bit flag, a fallback of the number for the MSG1 repetition from a lower number to a higher number.

7. The apparatus of claim 6, wherein the at least one processor, individually or in any combination, is further configured to:
indicate the lower number of the MSG1 repetition before the fallback and the higher number of the MSG1 repetition after the fallback.

8. The apparatus of claim 1, wherein the report includes the first RACH purpose indicating the RACH procedure is triggered for the link recovery procedure.

9. The apparatus of claim 8, wherein the link recovery procedure includes a synchronization of a timing advance during lower-layer-triggered mobility (LTM).

10. The apparatus of claim 1, wherein the report includes the second RACH purpose indicating the RACH procedure is initiated for the MT-SDT, and wherein the report further includes a comparison between a time gap associated with a start of the MT-SDT and a time threshold.

11. The apparatus of claim 10, wherein the time gap is a time interval between the start of the MT-SDT and a next configured grant (CG)-SDT occasion, and wherein the time threshold is a maximum duration allowed between the start of SDT and the next CG-SDT occasion.

12. The apparatus of claim 10, wherein the report further includes an uplink data volume prior to the initiation of the RACH procedure, or a data indicator indicating an availability of uplink SDT data.

13. The apparatus of claim 10, wherein the report further includes a reference signal received power (RSRP) prior to the initiation of the RACH procedure.

14. An apparatus for wireless communication at a network entity, comprising:
at least one memory; and
at least one processor coupled to the at least one memory and, based at least in part on information stored in the at least one memory, the at least one processor, individually or in any combination, is configured to:
initiate a random-access channel (RACH) procedure with a user equipment (UE); and
receive, from the UE upon a successful completion of the RACH procedure, a report, wherein the report includes one or more of:
an indicator indicating whether a message 1-repetition (MSG1-repetition) feature was utilized for the RACH procedure,
a first RACH purpose indicating the RACH procedure is triggered for a link recovery procedure, or
a second RACH purpose indicating the RACH procedure is initiated for mobile terminated-small data transfer (MT-SDT).

15. The apparatus of claim 14, further comprising a transceiver coupled to the at least one processor, wherein, to receive the report, the at least one processor, individually or in any combination, is configured to receive the report via the transceiver, and wherein the report is a RACH report.

16. The apparatus of claim 14, wherein the report includes the indicator indicating the MSG1-repetition feature was utilized, and wherein the report further includes a number for MSG1 repetition utilized during the RACH procedure.

17. The apparatus of claim 16, wherein the report further includes a threshold indicator indicating one quality threshold among multiple quality thresholds with which a downlink (DL) beam quality is measured, and wherein the multiple quality thresholds are respectively associated with different numbers of the MSG1 repetition.

18. The apparatus of claim 17, wherein the multiple quality thresholds are multiple synchronization signal block-reference signal received power (SSB-RSRP) thresholds.

19-22. (canceled)

23. The apparatus of claim 14, wherein the network entity is a first network entity, and wherein the at least one processor, individually or in any combination, is further configured to:
obtain statistics information related to the RACH procedure based on the report; and
transmit, for a second network entity, the statistics information.

24-28. (canceled)

29. A method of wireless communication at a user equipment (UE), comprising:
initiating a random-access channel (RACH) procedure with a network node;
generating, upon a successful completion of the RACH procedure, a report, wherein the report includes one or more of:
an indicator indicating whether a message 1-repetition (MSG1-repetition) feature was utilized for the RACH procedure,
a first RACH purpose indicating the RACH procedure is triggered for a link recovery procedure, or
a second RACH purpose indicating the RACH procedure is initiated for mobile terminated-small data transfer (MT-SDT); and
transmitting the report to the network node.

30. (canceled)
